(19) United States
(12) Patent Application Publication
(10) Pub. No.: US 2017/0220654 A1
(43) Pub. Date: Aug. 3, 2017

(54) METHOD FOR AUTOMATICALLY GENERATING EXTRACT TRANSFORM LOAD (ETL) CODES USING A CODE GENERATION DEVICE

(71) Applicant: Wipro Limited, Bangalore (IN)

(72) Inventors: Anindito De, Chennai (IN); Rajarajeswari Nagarajan, Chennai (IN)

(21) Appl. No.: 15/071,426

(22) Filed: Mar. 16, 2016

(30) Foreign Application Priority Data
Feb. 3, 2016 (IN) 201641003859

(51) Int. Cl. G06F 17/30

(52) U.S. Cl. CPC G06F 17/30563; G06F 17/30917

(57) ABSTRACT

A method and device for automatically generating Extract Transform Load (ETL) codes includes a code generation device that automatically detects one or more ETL patterns based on the received predefined ETL codes. The code generation device scans pattern database which comprises one or more ETL patterns to determine the presence of the one or more detected ETL patterns. Upon selecting the detected one or more ETL patterns by the user, the code generation device retrieves the selected one or more ETL patterns from the pattern database. User inputs are received for each of the one or more ETL patterns retrieved from the pattern database. The code generation device automatically identifies one or more ETL mappings from the primary data source to the secondary data source for each of the one or more ETL patterns and automatically generates ETL codes based on the one or more ETL mappings.

This application claims the benefit of Indian Patent Application Serial No. 201641003859 filed Feb. 3, 2016, which is hereby incorporated by reference in its entirety.

### FIELD

The present subject matter is related in general to software development process, and more particularly, but not exclusively to a method and a device for automatically generating extract transform load (ETL) codes.

### BACKGROUND

Generally Extract, Transform and Load (ETL) is a process in data warehousing responsible for pulling data out of the source systems and placing it into a data warehouse after applying necessary data transformation steps based on business requirements. Development of ETL programs is a slow process. The usual steps in the development process of ETL codes are creation of a detailed design document based on the source to target data mapping specification, coding and unit testing. These three steps are repeated for each ETL code that has to be developed. However, these three steps are time consuming and also expensive. Studies and statistics conclude that ETL code development is the root cause of 70% of the cost and time in product integration initiatives. Also, the ETL code development impacts the time to market for new product launches, delivery of new regulatory compliance information etc. On the other hand, manual development of ETL code results in defects and impacts the ability to meet requirements in time.

The existing systems follow a computer-executed method of generating an ETL workflow. This method of generating the ETL workflow includes receiving metadata. The metadata describes mapping between a source and a target, wherein the source and target describe an entity. The method further includes receiving an entity selection that specifies the entity. The workflow may be generated based on the metadata and the entity selection.

But the existing systems do not substantially cut down the time and cost in developing the ETL codes. To a large extent the existing methods are not completely automated. As a result of which defects still exist in the ETL codes that are developed.

### SUMMARY

One or more shortcomings of the prior art are overcome and additional advantages are provided through the present disclosure. Additional features and advantages are realized through the techniques of the present disclosure. Other embodiments and aspects of the disclosure are described in detail herein and are considered a part of the claimed disclosure.

Disclosed herein are a method and a device for automatically generating Extract Transform Load (ETL) codes. A code generation device automatically detects the one or more patterns from predefined ETL codes and retrieves the one or more patterns from a pattern database. The user provides required user inputs for the retrieved one or more ETL patterns, based on which one or more ETL patterns are identified. The ETL codes are generated automatically by the code generation device based on the one or more ETL mappings from a primary data source to a secondary data source.

Accordingly, the present disclosure comprises a method for automatically generating ETL codes. The method comprises detecting, by a code generation device, one or more ETL patterns based on predefined ETL codes. Thereafter, the code generation device determines presence of each of the detected one or more ETL patterns in a pattern database of the code generation device. Further, the code generation device retrieves the one or more ETL patterns from the pattern database. Upon retrieving the one or more ETL patterns, the code generation device receives user inputs for each of one or more parameter values, metadata related to a primary data source and metadata related to a secondary data source, corresponding to each of the one or more ETL patterns. Further, the code generation device automatically identifies one or more ETL mappings from the primary data source to the secondary data source based on the user inputs for each of the one or more ETL patterns. Thereafter, the code generation device automatically generates ETL codes corresponding to each of the one or more identified ETL mappings.

Further, the present disclosure comprises a code generation device for automatically generating ETL codes. The code generation device comprises a processor and a memory communicatively coupled to the processor. The memory stores the processor-executable instructions, which, on execution, causes the processor to detect one or more ETL patterns based on predefined ETL codes. Upon detecting the one or more ETL patterns, the processor determines presence of each of the detected one or more ETL patterns in a pattern database of the code generation device. Further, the processor retrieves one or more ETL patterns from the pattern database. Upon retrieving the one or more ETL patterns, the processor receives user inputs for each of one or more parameter values, metadata related to a primary data source and metadata related to a secondary data source, corresponding to each of the one or more ETL patterns. Further, the processor automatically identifies one or more ETL mappings from the primary data source to the secondary data source based on the user inputs for each of the one or more ETL patterns. Finally, the processor automatically generates ETL codes corresponding to each of the one or more identified ETL mappings.

Further, the present disclosure relates to a non-transitory computer readable medium including instructions stored thereon that when processed by at least one processor causes the code generating device to perform operations comprising detecting one or more ETL patterns based on predefined ETL codes. The instructions further cause the processor to determine presence of each of the detected one or more ETL patterns in a pattern database of the code generation device. Thereafter, the instructions cause the processor to retrieve one or more ETL patterns from the pattern database. Further, the instructions cause the processor to receive user inputs for each of one or more parameter values, metadata related to a primary data source and metadata related to a secondary data source, corresponding to each of the one or more ETL patterns. Thereafter, the instructions cause the processor to automatically identify one or more ETL mappings from the primary data source to the secondary data source based on the user inputs for each of the one or more ETL patterns. Finally the instructions cause the processor to automatically generate ETL codes corresponding to each of the one or more identified ETL mappings.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1a shows an exemplary architecture for automatically generating Extract Transform Load (ETL) codes in accordance with some embodiments of the present disclosure;

FIGS. 1b-1n show an exemplary process of automatically generating ETL codes in accordance with some embodiments of the present disclosure;

FIG. 2 shows a detailed block diagram of a code generation device for automatically generating ETL codes in accordance with some embodiments of the present disclosure;

FIG. 3 illustrates a flowchart for automatically generating Extract Transform Load (ETL) codes in accordance with some embodiments of the present disclosure; and

FIG. 4 is a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a device for automatically generating Extract Transform Load (ETL) codes. A code generation device receives predefined ETL codes from one or more sources. Upon receiving the predefined ETL codes, the code generation device automatically detects one or more ETL patterns present in the received predefined ETL codes. The code generation device scans a pattern database which comprises one or more ETL patterns to determine the presence of the one or more detected ETL patterns. If the detected one or more ETL patterns are present in the pattern database, a user selects the detected one or more ETL patterns. If the one or more detected ETL patterns are not present in the pattern database, the user creates the required one or more ETL patterns using a pattern editor of the code generation device. The created one or more ETL patterns are then updated to the pattern database and the user selects the detected one or more ETL patterns. Upon selecting the detected one or more ETL patterns, the code generation device retrieves the selected one or more ETL patterns from the pattern database. The user provides user inputs for each of the one or more ETL patterns retrieved from the pattern database. The user inputs are provided for each of one or more parameter values, metadata related to a primary data source and metadata related to a secondary data source, corresponding to each of the one or more ETL patterns. Upon receiving the user inputs, the code generation device automatically identifies one or more ETL mappings from the primary data source to the secondary data source for each of the one or more ETL patterns. If the identified one or more ETL mappings are not correct, the user changes the one or more ETL mappings. Finally, the code generation device automatically generates ETL codes based on the one or more ETL mappings from the primary data source to the secondary data source.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

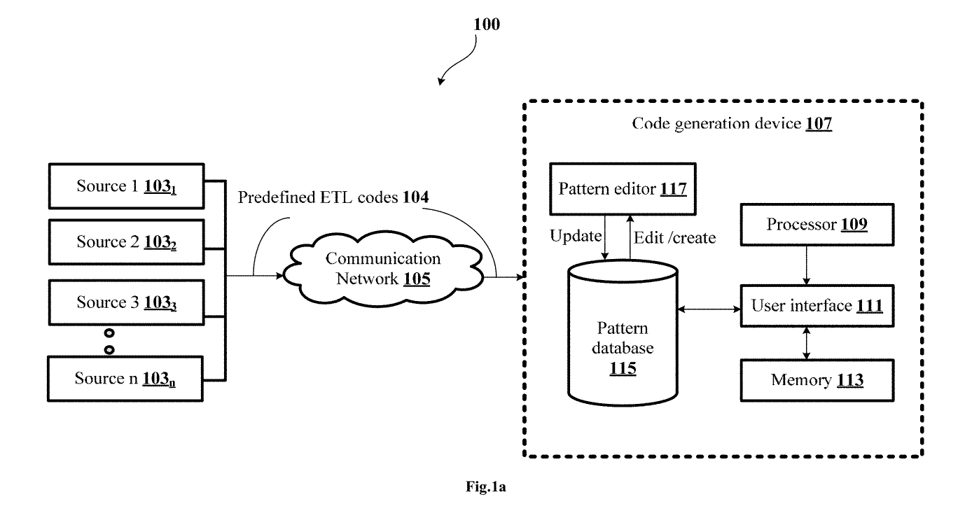

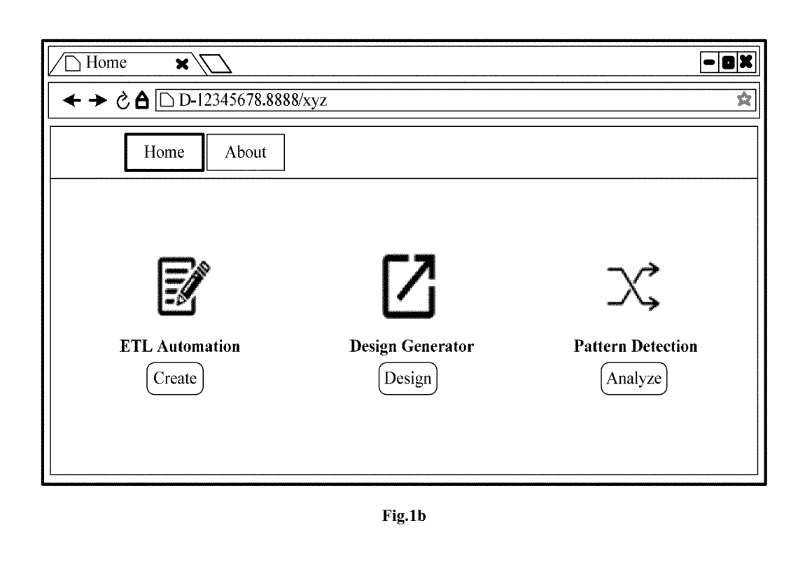

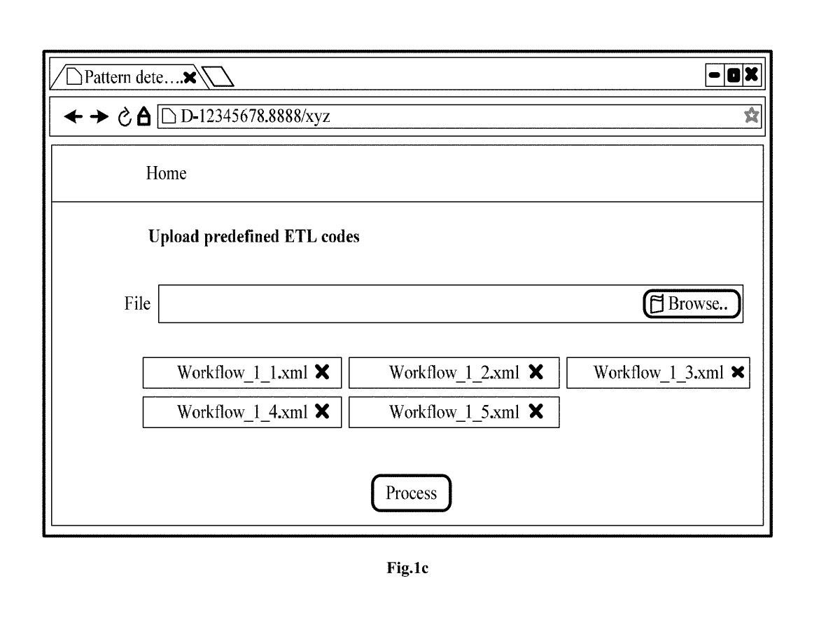

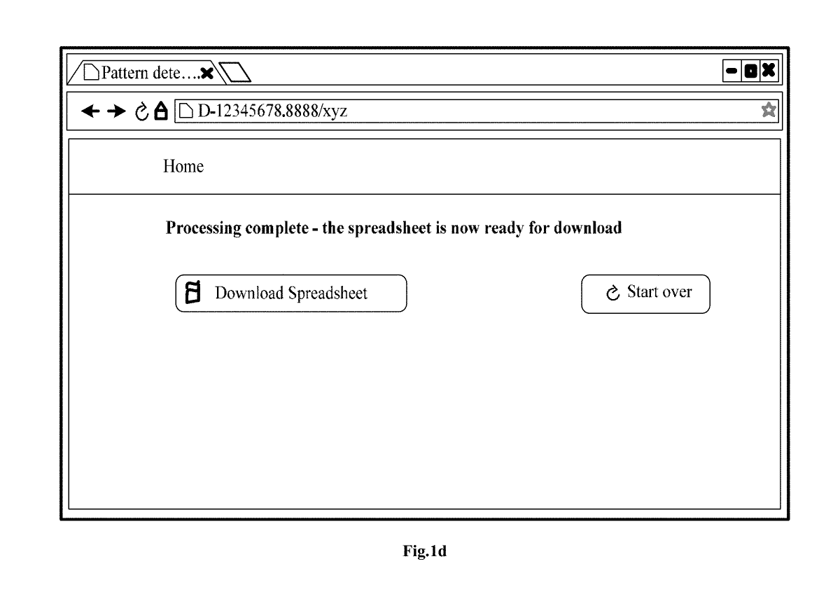

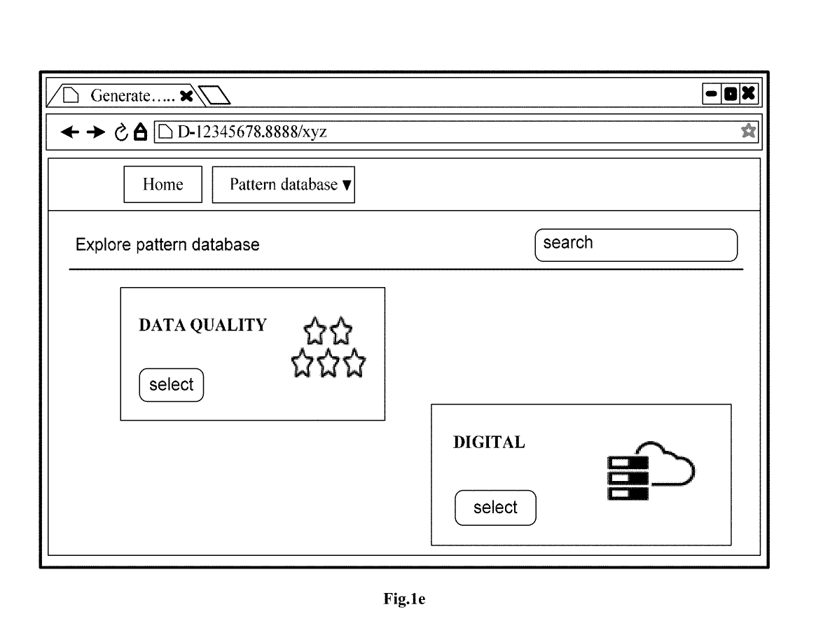

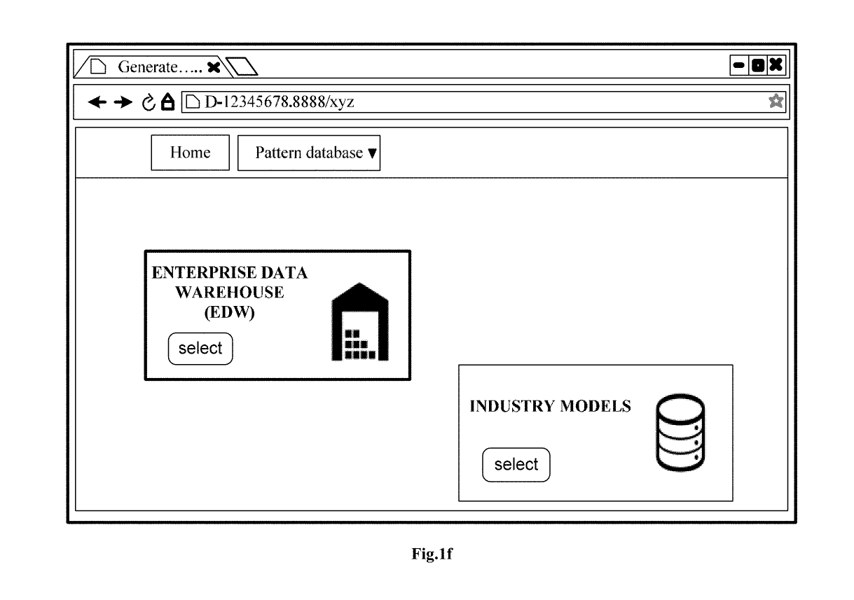

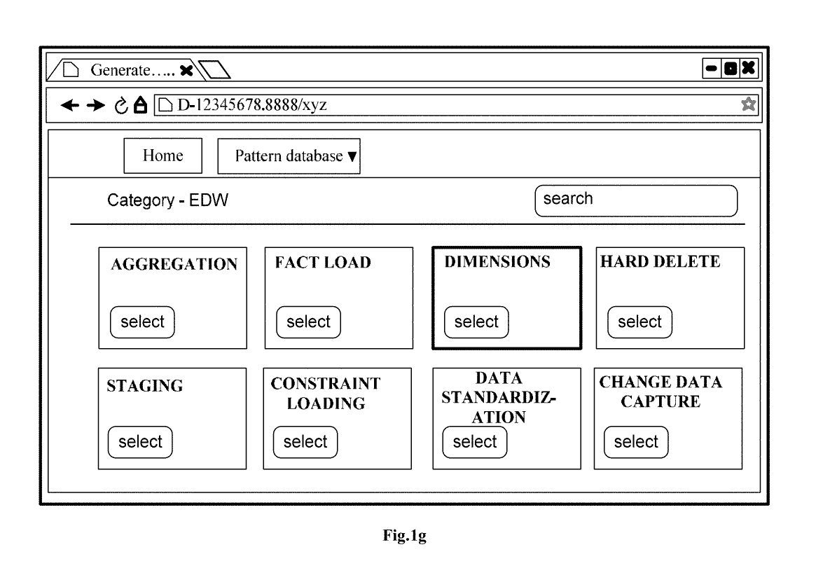

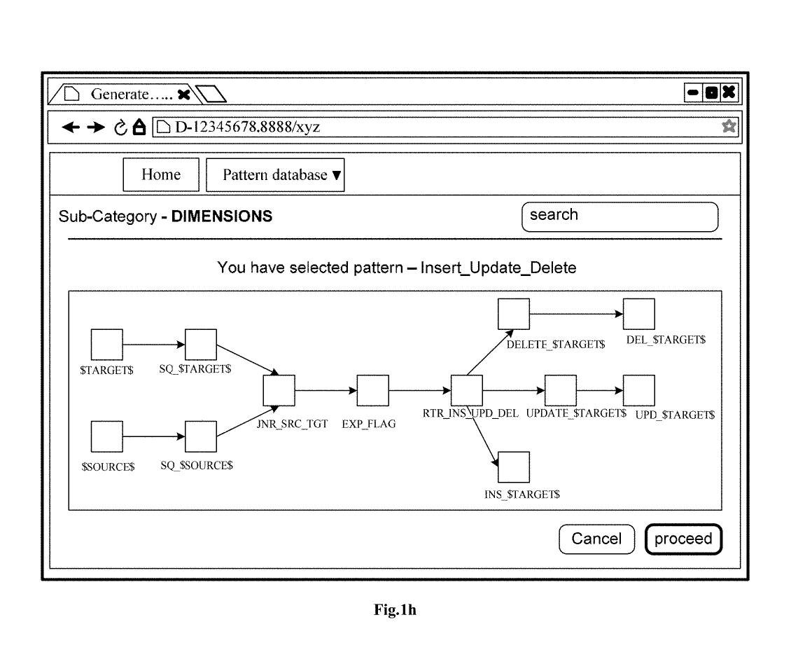

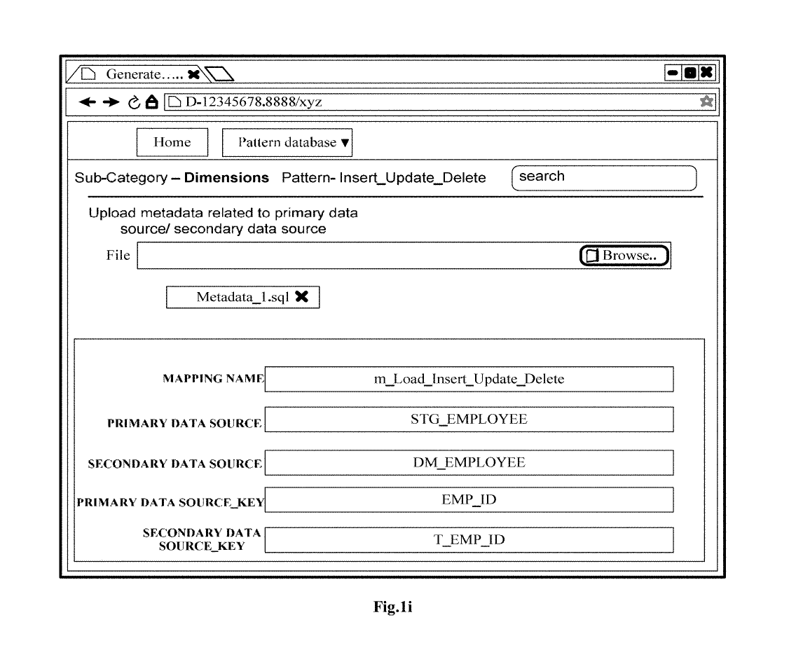

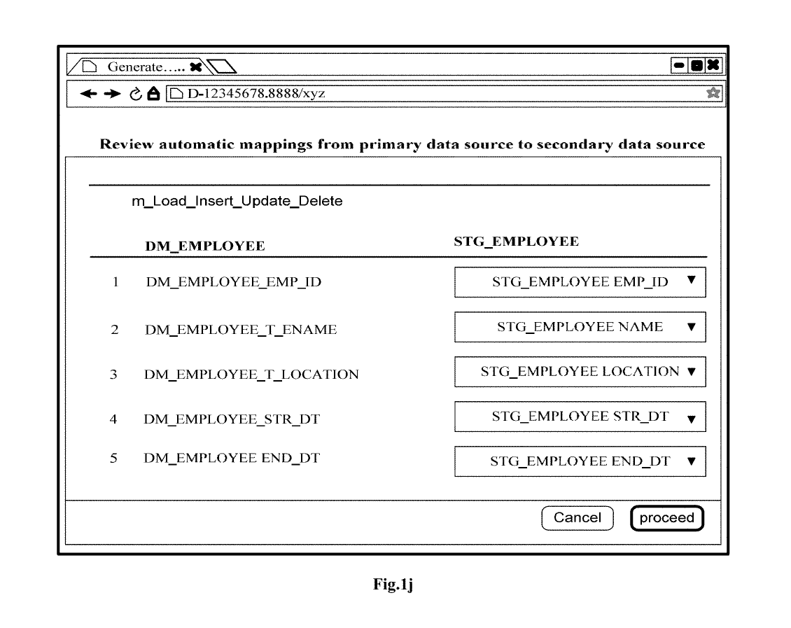

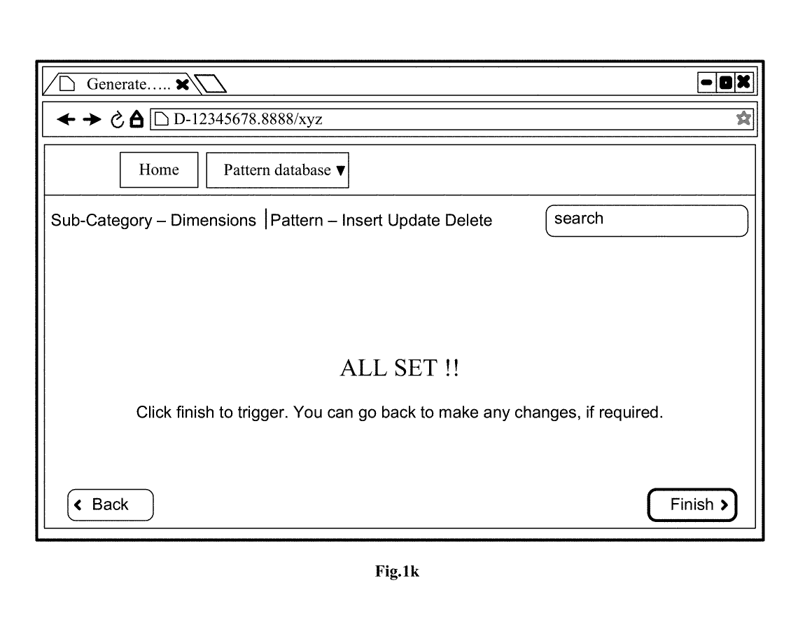

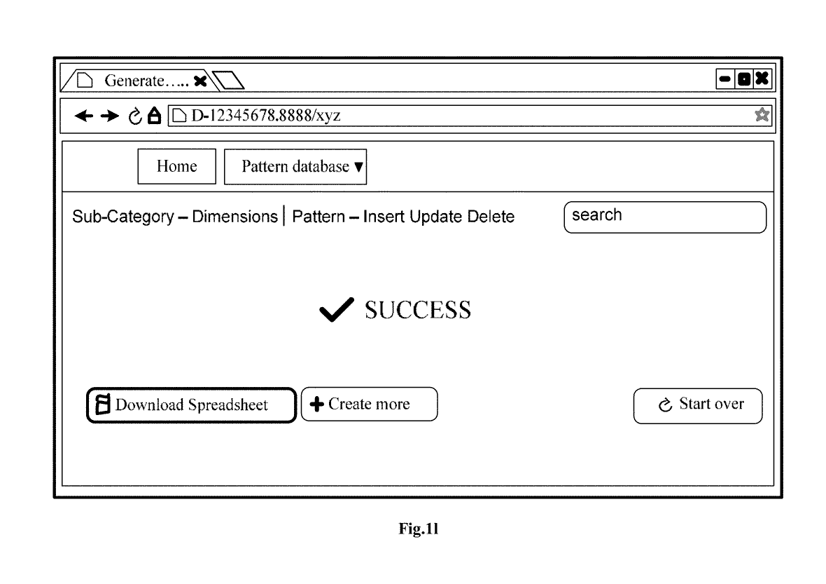

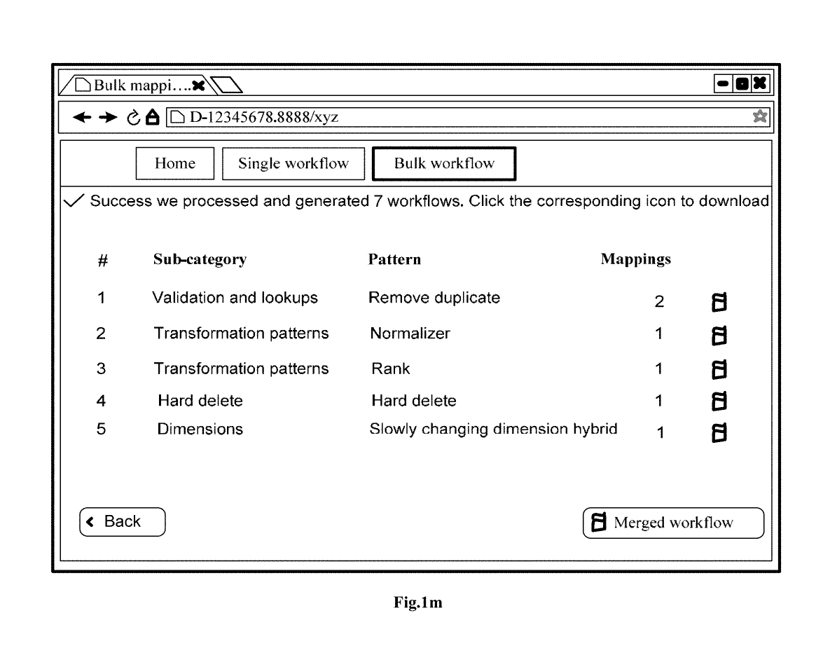

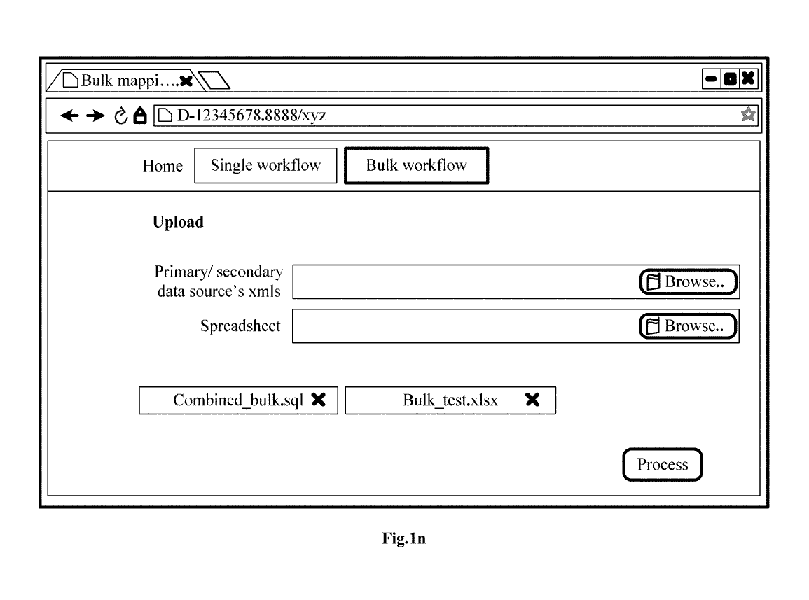

FIG. 1a shows an exemplary architecture for automatically generating Extract Transform Load (ETL) codes in accordance with some embodiments of the present disclosure;

The architecture 100 comprises one or more sources, source 1 1031 to source n 103n (collectively referred to as one or more sources 103), a communication network 105 and a code generation device 107. As an example, the one or more sources 103 may be a code database, a client/an end user etc. The communication network 105 maybe at least one of wired communication network and wireless communication network.

The one or more sources 103 may provide predefined ETL codes 104 to the code generation device 107 through the communication network 105. As an example, the predefined ETL codes 104 may be an Extensible Markup Language (XML) document. The predefined ETL codes 104 may provide information on one or more ETL patterns required to generate a new ETL code automatically. The code generation device 107 comprises a processor 109, a user interface 111, a memory 113, a pattern database 115 and a pattern editor 117. The processor 109 automatically detects the one or more ETL patterns present in the predefined ETL codes 104 as shown in FIG. 1b, FIG. 1c and FIG. 1d. A pattern detection icon is shown on the user interface 111 in FIG. 1b. Upon selecting the pattern detection icon, the processor 109 navigates to the page as shown in FIG. 1c. The XML, documents of the predefined ETL codes 104 are uploaded wherein the processor 109 automatically detects the one or more ETL patterns present in the uploaded predefined ETL codes 104. Upon detecting the one or more ETL patterns present in the uploaded predefined ETL codes 104, the detected one or more ETL patterns are provided to the user in a predefined format. As an example, the predefined format may be a spread sheet as shown in FIG. 1d.

The processor 109 further scans the pattern database 115 upon user's request through the user interface 111 i.e. the user can navigate through the pattern database 115 and choose the one or more ETL patterns displayed on the user interface 111. The pattern database 115 comprises one or more predefined ETL patterns related to one or more categories as shown in FIG. 1e and FIG. 1f. The one or more exemplary categories such as data quality and digital business intelligence are shown in FIG. 1e. The one or more exemplary categories such as Enterprise Data Warehouse (EDW) and industry models are shown in FIG. 1f. Each of the categories is divided into sub-categories comprising the one or more ETL patterns. As an example, FIG. 1g shows exemplary sub-categories such as aggregation, change data capture, constraint loading, data standardization, dimensions etc. The one or more ETL patterns can be selected from the sub-categories.

In an embodiment, the pattern database 115 is extensible i.e. the one or more ETL patterns can be added at regular time intervals or can be added as and when the one or more ETL patterns are created. In an embodiment, the pattern database 115 may be configured in the code generation device 107 or the pattern database 115 may be standalone which is associated with the code generation device 107. The processor 109 scans the pattern database 115 to check if the detected one or more ETL patterns are present in the pattern database 115 or not. If the detected one or more ETL patterns are present in the pattern database 115, a user selects the one or more ETL patterns and the processor 109 retrieves the one or more ETL patterns selected by the user. If the detected one or more ETL patterns are not present in the pattern database 115, the user can create the required one or more ETL patterns using the pattern editor 117 and the processor 109 retrieves the created one or more ETL patterns. The pattern editor 117 enables the user to edit or create the one or more ETL patterns. The pattern editor 117 also enables the user to choose functionality customized for the purpose of editing or creating. In an embodiment, the one or more ETL patterns can be created from scratch or the one or more ETL patterns can be created by selecting the one or more predefined ETL patterns. The pattern database 115 is updated with the created one or more ETL patterns for future reference. FIG. 1h shows the exemplary ETL pattern “insert update delete” from the category “EDW” and sub-category “Dimensions” selected by the user from the one or more ETL patterns present in the pattern database 115.

The retrieved one or more ETL patterns may be stored in the memory 113. Upon retrieving the one or more ETL patterns, user input are provided using the user interface 111. The user provides user inputs for one or more parameter values, metadata related to a primary data source and metadata related to a secondary data source, corresponding to each of the one or more ETL patterns, one by one as shown in FIG. 1i. The one or more parameter values are specific to each of the one or more ETL patterns. In an embodiment, the one or more parameters may be at least one of mapping parameters, session parameters and session connection information. Mapping parameters comprises the key attributes like name of the primary data source, name of the secondary data source and other related properties of the ETL pattern. Session parameters and session connection parameters may comprise properties related to the connections to be established for the ETL pattern and other related run time properties. In an embodiment, the metadata related to the primary data source comprises necessary data from where metadata required by the ETL pattern is loaded. As an example, the metadata related to the primary data source may be in the form of Structured Query Language (SQL) scripts, sample files, flat files etc. In an embodiment, the metadata related to the secondary data source comprises necessary data from where metadata required by the ETL pattern may be loaded. As an example, the metadata related to the secondary data source may be in the form of SQL scripts, sample files, flat files etc.

Upon providing the user inputs, the processor 109 automatically identifies one or more ETL mappings from the primary data source to secondary data source. The one or more ETL mappings corresponding to the selected exemplary ETL pattern are as shown in FIG. 1j.

The one or more ETL mappings may include, but not limited to, mapping operations, change of description, key indicators, primary data source information, secondary data source information and predefined business rules. If the identified one or more ETL mappings are correct, the user retains the automatically identified one or more ETL mappings. If the identified one or more ETL mappings are incorrect, the user edits the one or more ETL mappings using the user interface 111 to provide the correct one or more ETL mappings.

Upon mapping, the user interface 111 allows the user to go back and make changes if any as shown in FIG. 1k. If no changes are to be made, the user can select finish to proceed further. Finally, the processor 109 automatically generates the ETL codes corresponding to each of the one or more identified ETL mappings as shown in FIG. 11.

Each of the generated ETL codes comprises a session code, a workflow code and a mapping code corresponding to each of the one or more ETL patterns. The session code is associated with the connection information related to the connections and other runtime parameters to be established for the ETL pattern and other related run time properties. The workflow code is associated with the one or more sessions and tasks inside the sessions. The session is created and run inside the workflow code. The mapping code is associated with information associated with the one or more ETL mappings.

In an embodiment, the ETL codes corresponding to each of the one or more ETL patterns can be generated simultaneously as shown in FIG. 1m. The user inputs corresponding to each of the one or more patterns are given at a time in a predefined format as shown in the FIG. 1n. As an example, the predefined format may be in the form of a spread sheet.

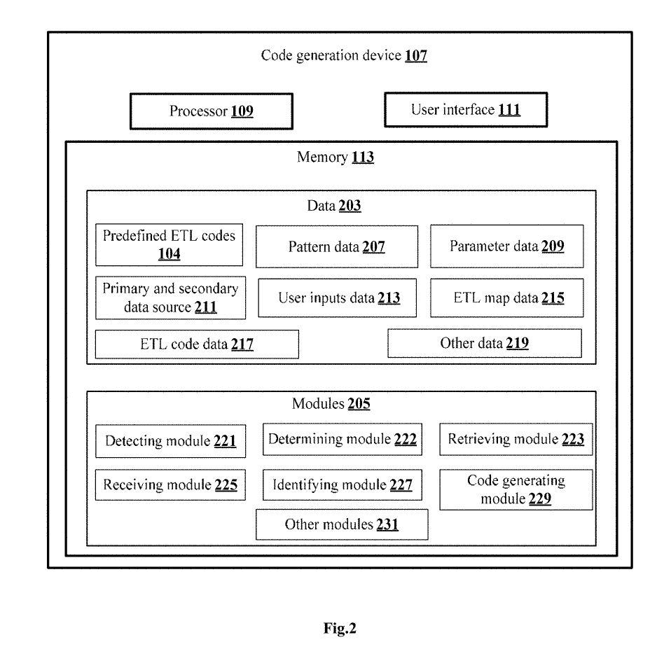

FIG. 2 shows a detailed block diagram of a code generation device for automatically generating ETL codes in accordance with some embodiments of the present disclosure.

In one implementation, the code generation device 107 receives data 203 from one or more sources 103. As an example, the data 203 may be stored in a memory 113 configured in the code generation device 107. In one embodiment, data 203 comprises predefined ETL codes 104, pattern data 207, parameter data 209, primary and secondary data source 211, user inputs data 213 ETL map data 215, ETL code data 217 and other data 219. In the illustrated FIG. 2, modules 205 stored in the memory 113 are described herein in detail.

In one embodiment, the data 203 may be stored in the memory 113 in the form of various data structures. Additionally, the aforementioned data 203 can be organized using data models, such as relational or hierarchical data models. The other data 219 may store data, including temporary data and temporary files, generated by modules 205 for performing the various functions of the code generation device 107.

In an embodiment, the predefined ETL codes 104 may be received from one or more sources 103 through the communication network 105. As an example, the one or more sources 103 may be a code database, a client/an end user etc. As an example, the predefined ETL codes 104 may be an Extensible Markup Language (XML) document. The predefined ETL codes 104 may provide information on one or more ETL patterns required to generate a new ETL code automatically.

In an embodiment, the pattern data 207 comprises one or more ETL patterns. The one or more ETL patterns are at least one of one or more predefined ETL patterns and the one or more ETL patterns created using a pattern editor 117 of the code generation device 107. The one or more ETL patterns can be created using the pattern editor 117 from scratch or by selecting the one or more predefined ETL patterns present in a pattern database 115. The pattern database 115 is updated with the created one or more ETL patterns for future reference.

In an embodiment, the parameter data 209 comprises one or more parameters. Each of the one or more ETL patterns is associated with the one or more parameters. The one or more parameters may be mapping parameters, session parameters and session connection parameters. Mapping parameters comprises the key attributes like name of the primary data source, name of the secondary data source and other related properties of the ETL pattern. Session parameters and session connection parameters may comprise properties related to the connections to be established for the ETL pattern and other related run time properties.

In an embodiment, primary and secondary data source 211 comprises metadata related to primary data source and metadata related to secondary data source required for each of the one or more ETL patterns. In an embodiment, the metadata related to the primary data source comprises necessary data from where metadata required by the ETL pattern is loaded. As an example, the metadata related to the primary data source may be in the form of Structured Query Language (SQL) scripts, sample files, flat files etc. In an embodiment, the metadata related to the secondary data source comprises necessary data from where metadata required by the ETL pattern may be loaded. As an example, the metadata related to the secondary data source may be in the form of SQL scripts, sample files, flat files etc.

In an embodiment, the user inputs data 213 comprises one or more inputs provided by a user. The user provides user inputs for one or more parameter values, the metadata related to the primary data source and the metadata related to the secondary data source corresponding to each of the one or more ETL patterns.

In an embodiment, the ETL map data 215 comprises one or more ETL mappings from the primary data source to the secondary data source. The one or more ETL mappings may include, but not limited to, mapping operations, change of description, key indicators, source information, target information and predefined business rules.

In an embodiment, the ETL code data 217 comprises one or more generated ETL codes. Each of the generated ETL codes comprises a session code, a workflow code and a mapping code corresponding to each of the one or more ETL patterns. The session code is associated with the connection information related to the connections to be established for the ETL pattern and other run time properties. The workflow code is associated with the one or more sessions and tasks inside the sessions. The session is created and run inside the workflow code. The mapping code is associated with information associated with the one or more ETL mappings from the primary data source to the secondary data source.

In an embodiment, the data stored in the memory 113 is processed by the modules 205 of the code generation device 107. The modules 205 may be stored within the memory 113 as shown in the FIG. 2. In an example, the modules 205, communicatively coupled to the processor 109, may also be outside the memory 113.

In an embodiment, the modules 205 may include, for example, a detecting module 221, a determining module 222, a retrieving module 223, a receiving module 225, an identifying module 227, a code generating module 229 and other modules 231. The other modules 231 may be used to perform various miscellaneous functionalities of the code generation device 107. It will be appreciated that such aforementioned modules 205 may be represented as a single module or a combination of different modules.

In an embodiment, the detecting module 221 automatically detects the one or more ETL patterns based on the predefined ETL codes 104 provided to the code generation device 107 from the one or more sources 103. The user uploads the XML documents of the predefined ETL codes 104 by selecting a pattern detection icon on the user interface 111. The detecting module 221 automatically detects the one or more ETL patterns based on the uploaded predefined ETL codes 104. Upon detecting the one or more ETL patterns based on the predefined ETL codes 104, the detected one or more ETL patterns are provided to the user in a predefined format. As an example, the predefined format may be a spread sheet.

In an embodiment, the determining module 222 determines presence of each of the detected one or more ETL patterns in the pattern database 115. The determining module 223 scans the pattern database 115 upon user's request through the user interface 111 i.e. the user can navigate through the pattern database 115 and choose the one or more ETL patterns displayed on the user interface 111. If the detected one or more ETL patterns are not present in the pattern database 115, the user creates the required one or more ETL patterns using a pattern editor 117.

In an embodiment, retrieving module 223 retrieves the detected one or more ETL patterns from the pattern database 115. The retrieved one or more ETL patterns may be stored in the memory 113.

In an embodiment, receiving module 225 receives user inputs for each of one or more parameter values, metadata related to a primary data source and metadata related to a secondary data source, corresponding to each of the one or more ETL patterns. The user inputs are provided using the user interface 111. In an embodiment, the user inputs corresponding to each of the one or more patterns can be provided in bulk at a time in a predefined format. As an example, the predefined format may be in the form of a spread sheet.

In an embodiment, the identifying module 227 automatically identifies one or more ETL mappings from the primary data source to secondary data source. If the identified one or more ETL mappings are correct, the user retains the automatically identified one or more ETL mappings. If the identified one or more ETL mappings are incorrect, the user edits the one or more ETL mappings using the user interface 111 to provide the correct one or more ETL mappings.

In an embodiment, the code generating module 229 automatically generates the ETL codes corresponding to each of the one or more identified ETL mappings. The generated ETL codes corresponding to each of the one or more ETL patterns can be generated simultaneously upon providing the user inputs in bulk.

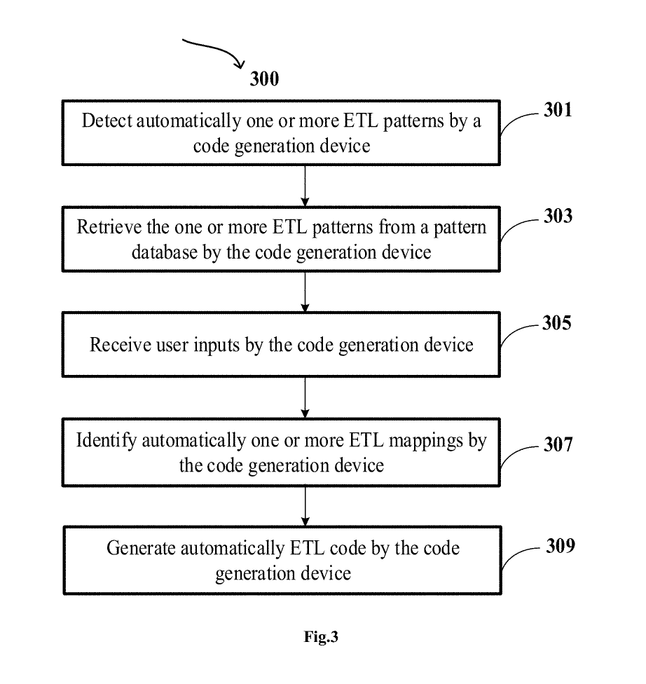

FIG. 3 illustrates a flowchart for automatically generating Extract Transform Load (ETL) codes in accordance with some embodiments of the present disclosure.

As illustrated in FIG. 3, the method 300 comprises one or more blocks illustrating a method for automatically generating ETL codes. The method 300 may be described in the general context of computer executable instructions. Generally, computer executable instructions can include routines, programs, objects, components, data structures, procedures, modules, and functions, which perform particular functions or implement particular abstract data types.

The order in which the method 300 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 301, the code generation device 107 automatically detects one or more ETL patterns. In an embodiment, processor 109 automatically detects the one or more ETL patterns based on predefined ETL codes 104 received from one or more sources 103. As an example, the predefined ETL codes 104 may be an Extensible Markup Language (XML) document. The processor 109 scans a pattern database 115 of the code generation device 107 upon user's request through the user interface 111 i.e. the user can navigate through the pattern database 115 and choose the one or more ETL patterns displayed on the user interface 111. The processor 109 scans the pattern database 115 to check if the detected ETL patterns are present in the pattern database 115 or not. If the detected ETL patterns are present in the pattern database 115, the processor 109 retrieves the one or more ETL patterns. If the detected ETL patterns are not present in the pattern database 115, a user can create the required one or more ETL patterns using the pattern editor 117.

At block 303, the code generation device 107 retrieves the one or more ETL patterns from the pattern database 115. In an embodiment, the detected one or more ETL patterns are retrieved from the pattern database 115 by the processor 109 and may be stored in the memory 113.

At block 305, the code generation device 107 receives user inputs. In an embodiment, the processor 109 receives the user inputs, wherein the user provides the user inputs through user interface 111 of the code generation device 107. The user provides user inputs for one or more parameter values, metadata related to a primary data source and metadata related to a secondary data source, corresponding to each of the one or more ETL patterns. The one or more parameter values are specific to each of the one or more ETL patterns. In an embodiment, the one or more parameters may be at least one of mapping parameters, session parameters and session connection information. In an embodiment, the metadata related to the primary data source provides the necessary data from where the metadata required for the ETL pattern is loaded. As an example, the metadata of the primary data source may be in the form of Structured Query Language (SQL) scripts, sample files, flat files etc. In an embodiment, the metadata related to the secondary data source provides the necessary data to which the metadata of the ETL pattern may be loaded. As an example, the metadata of the secondary data source may be in the form of SQL scripts, sample files, flat files etc.

At block 307, the code generation device 107 identifies one or more ETL mappings automatically. In an embodiment, the processor 109 automatically identifies one or more ETL mappings from the primary data source to secondary data source. The one or more ETL mappings may include, but not limited to, mapping operations, change of description, key indicators, source information, target information and predefined business rules. If the identified one or more ETL mappings are correct, the user retains the automatically identified one or more ETL mappings. If the identified one or more ETL mappings are incorrect, the user edits the one or more ETL mappings using the user interface 111 to provide the correct one or more ETL mappings.

At block 309, the code generation device 107 automatically generates an ETL code. In an embodiment, the processor 109 automatically generates the ETL code corresponding to each of the one or more identified ETL mappings from the primary data source to the secondary data source. The generated ETL code comprises a session code, a workflow code and a mapping code corresponding to each of the one or more ETL patterns. The session code is associated with the connection information related to the connections to be established for the ETL pattern and other run time properties. The workflow code is associated with the one or more sessions and tasks inside the sessions. The session is created and run inside the workflow code. The mapping code is associated with information associated with the one or more ETL mappings.

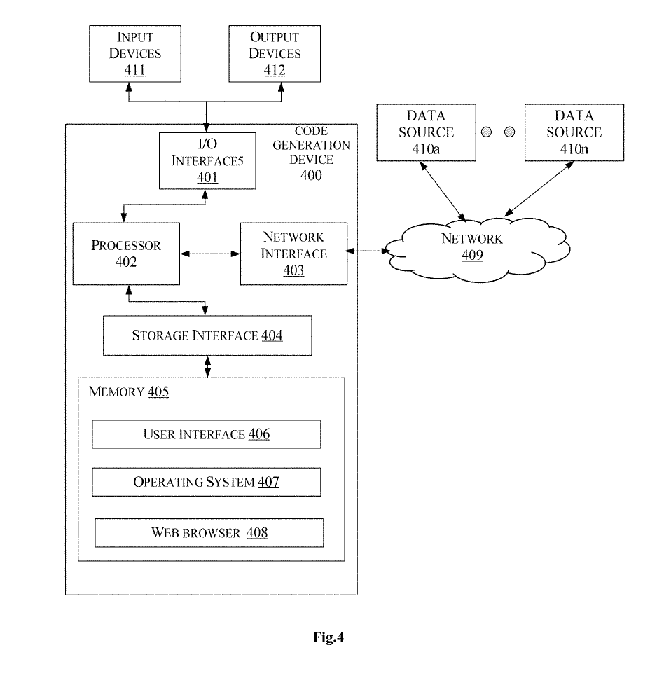

FIG. 4 is a block diagram of an exemplary computer system for implementing embodiments consistent with the present disclosure.

In an embodiment, the code generation device 400 is used for automatically generating Extract Transform Load (ETL) codes. The code generation device 400 may comprise a central processing unit (“CPU” or “processor”) 402. The processor 402 may comprise at least one data processor for executing program components for executing user- or system-generated business processes. A user may include a person, a person using a device such as such as those included in this invention, or such a device itself. The processor 402 may include specialized processing units such as integrated system (bus) controllers, memory management control units, floating point units, graphics processing units, digital signal processing units, etc.

The processor 402 may be disposed in communication with one or more input/output (I/O) devices (411 and 412) via I/O interface 401. The I/O interface 401 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, 5-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 401, the code generation device 400 may communicate with one or more I/O devices (411 and 412).

In some embodiments, the processor 402 may be disposed in communication with a communication network 409 via a network interface 403. The network interface 403 may communicate with the communication network 409. The network interface 403 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 403 and the communication network 409, the code generation device 400 may communicate with one or more user devices 410 (a, . . . ,n). The communication network 409 can be implemented as one of the different types of networks, such as intranet or Local Area Network (LAN) and such within the organization. The communication network 409 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 409 may include a variety of network devices, including routers, bridges, servers, computing devices, storage devices, etc. The one or more user devices 410 (a, . . . ,n) may include, without limitation, personal computer(s), mobile devices such as cellular telephones, smartphones, tablet computers, eBook readers, laptop computers, notebooks, gaming consoles, or the like.

In some embodiments, the processor 402 may be disposed in communication with a memory 405 (e.g., RAM, ROM, etc. not shown in FIG. 4) via a storage interface 404. The storage interface 404 may connect to memory 405 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 405 may store a collection of program or database components, including, without limitation, user interface application 406, an operating system 407, web server 408 etc. In some embodiments, code generation device 400 may store user/application data 406, such as the data, variables, records, etc. as described in this invention. Such databases may be implemented as fault-tolerant, relational, scalable, secure databases such as Oracle or Sybase.

The operating system 407 may facilitate resource management and operation of the code generation device 400. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 406 may facilitate display, execution, interaction, manipulation, or operation of program components through textual or graphical facilities. For example, user interfaces may provide computer interaction interface elements on a display system operatively connected to the code generation device 400, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the code generation device 400 may implement a web browser 408 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the code generation device 400 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the code generation device 400 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, non-volatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure provides a method and a device for automatically generating Extract Transform Load (ETL) codes.

The present disclosure utilizes a pattern based technique to generate ETL codes. The present disclosure also provides an extensible pattern database wherein one or more ETL patterns are stored.

The present disclosure provides a pattern editor using which, a user can create one or more ETL patterns and update the created patterns in the pattern database for future reference.

The present disclosure provides a feature wherein the pattern database can be customized at an organization level.

The present disclosure drastically cuts down the effort of ETL code development by 60% which in turn improves the marketing time and the cost involved in developing the ETL codes.

The present disclosure is automated. Therefore the quality of the ETL code developed is high and the number of defects occurring in the ETL code reduces up to 50%.

The present disclosure improves the time and cost involved in developing ETL codes. As a result of which the developers can focus more on analysis and design.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The specification has described a method and a device for automatically generating Extract Transform Load (ETL) codes. The illustrated steps are set out to explain the exemplary embodiments shown, and it should be anticipated that on-going technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. A method for automatically generating Extract Transform Load (ETL) codes, the method comprising:
detecting, by a code generation device, one or more ETL patterns based on predefined ETL codes;
determining, by the code generation device, presence of each of the detected one or more ETL patterns in a pattern database of the code generation device;
retrieving, by the code generation device, the one or more ETL patterns from the pattern database;
receiving, by the code generation device, user inputs for each of one or more parameter values, metadata related to a primary data source and metadata related to a secondary data source, corresponding to each of the one or more ETL patterns;
identifying, by the code generation device, automatically one or more ETL mappings from the primary data source to the secondary data source based on the user inputs for each of the one or more ETL patterns; and
generating, by the code generation device, automatically ETL codes corresponding to each of the one or more identified ETL mappings.

2. The method as claimed in claim 1, wherein the one or more ETL patterns are created using a pattern editor of the code generation device when the one or more ETL patterns detected by the code generation device are not present in the pattern database.

3. The method as claimed in claim 2 further comprises updating, by the code generation device, the pattern database with the one or more ETL patterns being created.

4. The method as claimed in claim 1 further comprises generating, by the code generation device, ETL codes corresponding to each of the one or more ETL patterns simultaneously by providing the one or more user inputs for each of the one or more parameter values, metadata related to a primary data source and metadata related to a secondary data source, corresponding to each of the one or more ETL patterns in a predefined format.

5. The method as claimed in claim 1, wherein each of the automatically generated ETL codes comprises a session code associated with connection information and run-time properties, a workflow code associated with one or more sessions and tasks inside the sessions and a mapping code associated with each of the one or more ETL patterns.

6. The method as claimed in claim 1, wherein the one or more parameter values comprises information related to mapping parameters, session parameters or session connection parameters.

7. A code generation device for automatically generating Extract Transform Load (ETL) codes, the code generation device comprising:
a processor; and
a memory communicatively coupled to the processor, wherein the memory stores the processor-executable instructions, which, on execution, causes the processor to:
detect one or more ETL patterns based on predefined ETL codes;
determine presence of each of the detected one or more ETL patterns in a pattern database of the code generation device;
retrieve one or more ETL patterns from the pattern database;
receive user inputs for each of one or more parameter values, metadata related to a primary data source and metadata related to a secondary data source, corresponding to each of the one or more ETL patterns;
identify automatically one or more ETL mappings from the primary data source to the secondary data source based on the user inputs for each of the one or more ETL patterns; and
generate automatically ETL codes corresponding to each of the one or more identified ETL mappings.

8. The code generation device as claimed in claim 7, wherein the processor is further configured to execute processor-executable instructions to create the one or more ETL patterns using the pattern editor when the one or more ETL patterns detected by the code generation device is not present in the pattern database.

9. The code generation device as claimed in claim 7, wherein the processor is further configured to execute processor-executable instructions to update the pattern database with the one or more ETL patterns being created.

10. The code generation device as claimed in claim 7, wherein the processor is further configured to execute processor-executable instructions to generate ETL codes corresponding to each of the one or more ETL patterns simultaneously by providing the one or more user inputs for each of the one or more parameter values, metadata related to a primary data source and metadata related to a secondary data source, corresponding to each of the one or more ETL patterns in a predefined format.

11. The code generation device as claimed in claim 7, wherein each of the automatically generated ETL codes comprises a session code associated with connection information and run-time properties, a workflow code associated with one or more sessions and tasks inside the sessions and a mapping code associated with each of the one or more patterns.

12. The code generation device as claimed in claim 7, wherein the one or more parameter values comprises information related to mapping parameters, session parameters or session connection parameters.

13. A non-transitory computer readable medium including instructions stored thereon that when processed by at least one processor causes a code generating device to perform operations comprising:
detecting one or more ETL patterns based on predefined ETL codes;
determining presence of each of the detected one or more ETL patterns in a pattern database of the code generation device;
retrieving one or more ETL patterns from the pattern database;
receiving user inputs for each of one or more parameter values, metadata related to a primary data source and metadata related to a secondary data source, corresponding to each of the one or more ETL patterns;
identifying automatically one or more ETL mappings from the primary data source to the secondary data source based on the user inputs for each of the one or more ETL patterns; and
generating automatically ETL codes corresponding to each of the one or more identified ETL mappings.

14. The medium as claimed in claim 13, wherein the instructions cause the processor to create the one or more ETL patterns using the pattern editor when the one or more ETL patterns detected by the code generation device is not present in the pattern database.

15. The medium as claimed in claim 13, wherein the instructions cause the processor to update the pattern database with the one or more ETL patterns being created.

16. The medium as claimed in claim 13, wherein the instructions cause the processor to generate ETL codes corresponding to each of the one or more ETL patterns simultaneously by providing the one or more user inputs for each of the one or more parameter values, metadata related to a primary data source and metadata related to a secondary data source, corresponding to each of the one or more ETL patterns in a predefined format.
